(19) United States
(12) Patent Application Publication
(10) Pub. No.: US 2011/0142898 A1
(43) Pub. Date: Jun. 16, 2011

(54) DEVICES FOR TREATMENT OF SKIN DISORDERS

(76) Inventor: Jerry Fan, Alhambra, CA (US)

(21) Appl. No.: 12/636,560

(22) Filed: Dec. 11, 2009

(51) Int. Cl. A01N 25/34

(52) U.S. Cl. 424/404

(57) ABSTRACT

The present invention discloses a layer of fabrics having antibacterial/microbe-resistant properties that are designed for contacting with the human skin. The fabric layer can be disposed, directly or indirectly, onto a pillowcase, pillow, comforter, comforter cover, head support, bed cloth, sleeping bag, mattress, cushion, blanket, and garment.

### BACKGROUND OF THE INVENTION

This invention relates to an article and/or a device with an antibacterial/microbe-resistant fiber layer for treating and preventing skin disorders.

In recent years consumers have growing concerns about exposing their skins to hazards of microorganisms, which may cause various types of skin issues such as acne and allergies. Some attempt to battle these skin disorders by regularly washing faces or applying medications topically to reduce infections. These attempts, however, are significantly counterbalanced when the human skin stays in contact during sleeping hours with conventionally-made bedding items such as pillowcases and bedding sheets. Those bedding items are oftentimes breeding grounds for germs, bacteria, and other foreign substances harmful to the skin.

The skin disorders caused by microorganisms are usually aggravated if the bedding cloth is not cleaned frequently. Human's dead skin cells, grease, sweat, and other excretions accumulated on the cloth surface serve as ideal food supply for the microorganisms. Over time, the contaminated bedding fabrics will repeatedly infect the human skin despite other efforts to treat the skin ailments.

In addition. consumers are often misled to believe that the higher thread count represents better quality for the bedding textile, From the perspective of dermatology, however, the higher thread count impedes ventilation of the fabric, thus blocking skin cells breathing functionalities. Certain skin syndromes such as acne eruptions/vulgaris, rashes and pustules could be caused or aggravated by fabrics with exceedingly high thread counts.

### SUMMARY OF THE INVENTION

Given the above deficiencies of prior art, a need remains for a fabrics article, especially bedding items, to effectively prevent and treat skin disorders, The present invention satisfies such a need by providing a fabrics article that ensures the healthy condition of the user by greatly reducing incidences of exposure to germs, bacteria, or pathogens so often associated with certain skin issues.

According to one aspect of the present invention, a layer of fabrics having antibacterial/microbe-resistant properties is designed for contacting with the human skin. The fabric layer can be disposed, directly or indirectly, onto a pillowcase, pillow, comforter, comforter cover, head support, bed cloth, sleeping bag, mattress, cushion, blanket, and garment. The antibacterial/microbe-resistant properties may come from natural attributes of the fabrics, such as bamboo fibers. Alternatively, the layer of fabrics has antibacterial/microbe-resistant agent adhered thereto such as silver ion, silver element, and silver composite.

In another aspect, the present invention further comprises an indicator thereupon for indicating the grease level contained in the layer. In some embodiments, the indicator can show passage of time. A label can be included to inform a user of how to use the antibacterial/microbe-resistant pillowcase, for example.

The thread count of the fabrics layer advantageously ranges between 150 and 350.

### BRIEF DESCRIPTION OF THE DRAWINGS

FIG. 1 is a perspective view of a pillowcase according to one preferred embodiment of the present invention.

FIG. 2 provides an enlarged, cross sectional view of a portion of he pillowcase in reference to FIG. 1.

### DETAILED DESCRIPTION OF THE PREFERRED EMBODIMENT(S)

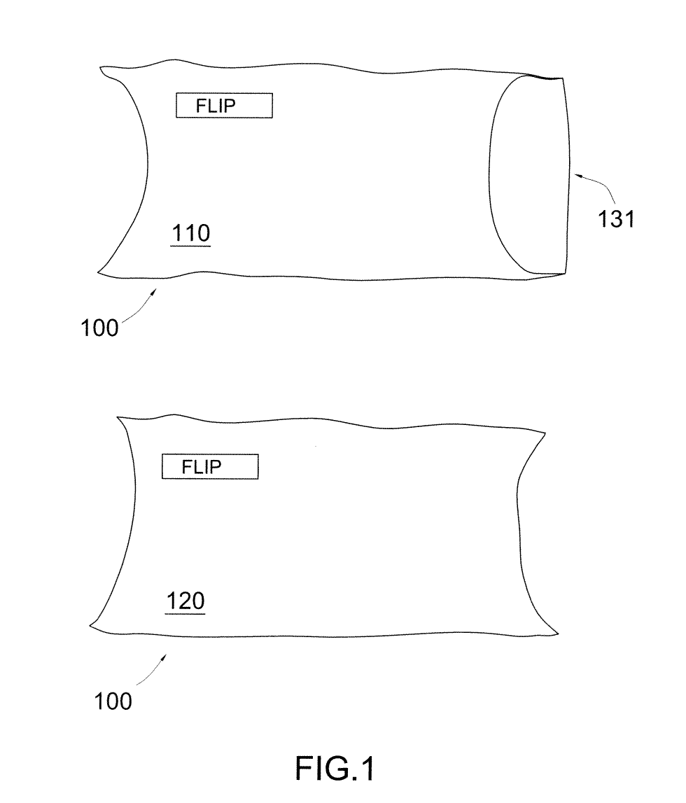

FIG. 1 is a perspective view of a pillowcase 100 according to one preferred embodiment of the present invention. The pillowcase 100 is comprised of a cloth cover with a front side 110 and a back side 120. The pillowcase 100 is generally designed for a pillow 130 to be inserted from one end to substantially fill the space inside. At least one side of the pillowcase 100 is in direct contact with the skin of a user lying on the pillow 130.

The pillowcase 100 provides antibacterial and/or microbe-resistant effect for killing and removing microorganisms (including e.g., germs, bacteria, fungi, and virus), that may cause various skin infections and conditions. The pillowcase 100 is particularly suitable for acne sufferers and places where the beds are frequently used by various people, such as hospitals, hotels, and hostels.

In some embodiments, the pillowcase 100 is made of textiles with inherent antibacterial/microbe-resistant attributes such as bamboo fibers and synthetic fabrics such as polyester, acetate, and acrylic.

As to fibers lacking inherent antibacterial/microbe-resistant attributes, substances with such properties can be added onto those fibers to achieve the same effect. By way of example, the antibacterial/microbe-resistant agent can be delivered during the process of making a synthetic fiber; in addition, fibers can acquire those properties through applying antibacterial/microbe-resistant materials thereon or using binders to adhere compositions thereto.

Antibacterial/microbe-resistant substances include metals known for their anti-microbial properties, such as silver, copper and zinc. Preferably, the yarn of the pillowcase 100 contains nano-silver particles with diameters ranging from 1 nm to 100 nm, The silver adhered to the fabrics is preferably 0.2% to 1.5% of the total weight of the yarn. The ions of those metals and combinations thereof also can be held to yarns that are woven or knit into the pillowcase 100. Well-known examples include Ag+, AgNo₃, silver halide, and other silver salts.

The pillowcase 100 can be made of various textiles, including natural fibers such as cotton, linen, silk, wool, etc.; synthetic fabrics such as nylon, polyester, acrylic, urethane fiber, etc.; and a blend of the afore-mentioned fabrics. Preferably, the textile employed for the pillowcase 100 has a refreshing smell and pleasant scent.

Aside from pillowcases, the foregoing fabrics with either inherent or added antibacterial/microbe-resistant attributes can be used in various articles that may come into contact with the human skin: head support for airplanes, coaches, trains, ships, cars, and other transport vehicles; bedding items such as pillows, bed cloth, comforter and comforter covers, blankets, cushions, mattresses, sleeping bag, etc.; and garments such as hat, underwear, robes and scarf.

Referring to FIG. 1, an indicator 140 and 150 is installed on the front side 110 and back side 120 of the pillowcase, which indicates the grease level of the pillowcase 100. As discussed above, grease and other human excretions provide microorganisms with a suitable environment to live on, thus aggravating skin disorders such as acne and allergies. The inclusion of the grease indicator on the pillowcase 100 can remind the user of cleaning or laundering the pillowcase 100 more frequently so as to prevent microbial prevalence.

The indicator 140 and 150 is capable of detecting how much oil or grease is contained in the pillowcase 100 and reacts by showing a change, such as color variations or indices. By way of example, when the oil contained in the pillowcase 100 has reached the saturation level, the indicator 140 and 150 turns red or displays a reminder “FLIP” as shown in FIG. 1. The indicator 140 and 150 can be implemented by employing an oil test to determine the grease content of the pillowcase 100. In other embodiments, the indicator 140 and 150 demonstrates the passage of time by using some suitable materials with characteristics exhibiting state changes with time, e.g., colors.

Preferably, the indicator 140 and 150 is a label with designations or marks thereon to inform the user of when to flip or launder the pillowcase 110, By way of example, one label with designations Mon/Tue/Wed may be attached to the front side 110, pointing out to the user that the front side is for use on only Monday, Tuesday, and Wednesday, while a label with designations Thurs/Fri/Sat is affixed to the back side 120, signifying that the back side should be used only on Thursday, Friday and Saturday.

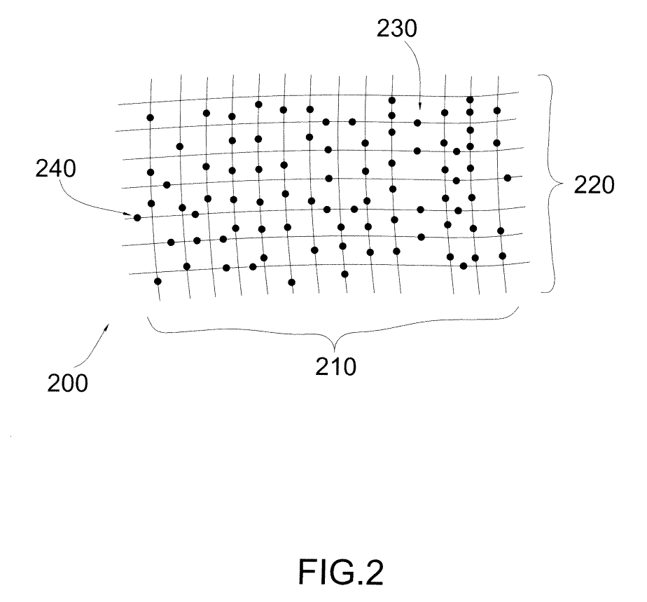

FIG. 2 provides an enlarged, cross sectional view of a portion of the pillowcase 100 in reference to FIG. 1. More specifically, the cover of the pillowcase 100 is formed of threads 200 that are interlaced with each other, including both length (warp) threads 210 and width (weft) threads 220. Thread count can be measured in many ways, preferably by the number of threads per inch (“TPI”), counted along two sides (up and across). Courseness or fineness for fabrics is typically measured by thread counts.

The thread count of fabrics that compose the pillowcase 100 is an important factor in determining the fabric's permeability/breathability and consequently affects the pillow's curing properties. Superior permeability/breathability creates cooler temperature and appropriate moisture to inhibit the growth of microorganisms. When the thread count increases, the permeability/breathability deteriorates. This is because the space 230, which is defined by warp and weft threads, greatly reduces in size with increasing thread counts. Air flow through the space 230 is therefore hindered, resulting in heightened temperature and moisture. The resulting heat and humidity provides a suitable environment for microorganisms, which in turn aggravate the skin ailments.

On the other hand, an overly low thread count could also lessen the curing effect of the pillowcase 100. As depicted in FIG. 2, anti-bacterial particles, collectively identified by reference numeral 240, disperse on various portions of the threads 200. The lower the thread count is, the looser those particles are scattered. As those agents decrease in density, their anti-bacterial/microbe-resistant effect would correspondingly diminish.

An optimal range of the thread count according to the present invention is 150 to 350, which can be applied in pillowcases as well as other articles such as bedding items and those set forth above.

Having now described the invention in accordance with the requirements of the patent statutes, those skilled in the art will understand how to make changes and modifications in the present disclosure to meet their specific requirements or conditions. Such changes and modifications may be made without departing from the scope and spirit of the invention as set forth in the following claims.

What is claimed is:

1. An article adapted for contacting with human skin to prevent or reduce skin disorders, the article comprising:
a layer of fabric for contacting with the human skin; and
an indicator attached on the fabric layer for indicating the condition of the layer,

2. The article of claim 1, wherein the condition is grease contained in the fabric layer.

3. The article of claim 1, wherein the condition is passage of time.

4. The article of claim 1, wherein the condition is a designation for informing a user of how to use the article.

5. The article of claim 1. wherein the fabric layer includes bamboo fiber.

6. The article of claim 1, the fabric layer comprising microbe-resistant agent adhered thereto, wherein the agent includes one of the following:
silver;
silver ion;
silver composite;
copper;
copper ion;
copper composite;
zinc;
zinc ion; and
zinc composite.

7. The article of claim 1, the fabric layer including 0.2% to 1.5% of silver by weight of the total weight of the fabric.

8. The article of claim 1, the fabric layer including silver particles with diameters ranging between 1 nm to 100 nm,

9. The article of claim 1, wherein the fabric layer is disposed at least partially over one of the following, directly or indirectly:
pillowcase;
pillow;
head support;
bed cloth;
comforter;
comforter cover;
sleeping bag;
mattress;
cushion;
blanket; and
garment.

10. The article of claim 1, wherein the thread count of the fabric layer ranges between 150 and 350.

11. An article adapted for contacting with human skin to prevent skin disorders, the article comprising a layer of fabric with microbe-resistant properties for contacting with the human skin, wherein the fabric layer has a thread count ranging between 150 and 350.

12. The article of claim 11, further comprising an indicator attached on the fabric layer for indicating a condition of the layer.

13. The article of claim 12, wherein the condition is grease contained in the fabric layer and indicates the grease level therein.

14. The article of claim 12, wherein the condition is passage of time.

15. The article of claim 12, wherein the condition is designations for informing a user of how to use the article.

16. The article of claim 11, wherein the fabric layer includes bamboo fiber.

17. The article of claim 11, the fabric layer comprising microbe-resistant agent adhered thereto, wherein the agent includes one of the following:
silver;
silver ion;
silver composite;
copper;
copper ion;
copper composite;
zinc;
zinc ion; and
zinc composite.

18. The article of claim 11, the fabric layer comprising 0.2% to 1.5% of silver by weight.

19. The article of claim 18, wherein the silver is made up of particles with diameters ranging between 1 nm to 100 nm.

20. The article of claim 11, wherein the fabric layer is disposed at least partially over one of the following articles:
pillowcase;
pillow;
head support;
bed cloth;
comforter;
comforter cover;
sleeping bag;
mattress;
cushion;
blanket; and
garment.

21. An article adapted for contacting with human skin to prevent skin disorders, the article comprising a layer of bamboo fiber.

22. The article of claim 21, further comprising an indicator attached on the fabric layer for indicating a condition of the layer.

23. The article of claim 22, wherein the condition is grease contained in the fabric layer.

24. The article of claim 22, wherein the condition is passage of time.

25. The article of claim 22, wherein the condition is designations for informing a user of how to use the article.

26. The article of claim 21, wherein the fabric layer is disposed at least partially over one of the following, directly or indirectly:
pillowcase;
pillow;
head support;
bed cloth;
comforter;
comforter cover;
sleeping bag;
mattress;
cushion;
blanket; and
garment.
